(19) United States
(12) Patent Application Publication
(10) Pub. No.: US 2015/0014433 A1
(43) Pub. Date: Jan. 15, 2015

(54) SYSTEMS AND METHODS FOR ULTRASONIC SPRAYING

(71) Applicant: TEMPTU, INC., New York, NY (US)

(72) Inventors: Jonathan D. Albert, Philadelphia, PA (US); Christopher T. Phelan, Collingswood, NJ (US)

(73) Assignee: TEMPTU, INC., New York, NY (US)

(21) Appl. No.: 14/188,353

(22) Filed: Feb. 24, 2014

Related U.S. Application Data
(60) Provisional application No. 61/768,338, filed on Feb. 22, 2013.

(51) Int. Cl. B05B 17/06

(52) U.S. Cl. CPC B05B 17/0615
USPC 239/102.2

(57) ABSTRACT

The disclosure provides systems and methods for ultrasonic spraying of fluids. In some embodiments, the disclosure provides systems and methods for spraying cosmetic fluids using handheld spray devices.

### CROSS-REFERENCE

This application claims the benefit of U.S. Provisional Application No. 61/768,338, filed Feb. 22, 2013, which application is incorporated herein by reference in its entirety.

### SUMMARY

Provided herein are systems and methods for ultrasonic spraying of fluids. Some embodiments provide systems and methods for spraying cosmetic fluids using handheld spray devices.

An aspect of the invention relates to an ultrasonic spray device comprising: a device body; an ultrasonic transducer; a nozzle; a removable cartridge that is positioned within the device body, wherein the cartridge further includes: a fluid; a means of delivering said fluid; a passageway that upon insertion into the device is in communication with the nozzle.

A further aspect of the invention relates to an ultrasonic spray device comprising: a device body; an ultrasonic transducer; a nozzle; a removable cartridge positioned within the device body, wherein the cartridge further includes: a fluid; a means of delivering said fluid; a passageway that upon insertion into the device is in communication with the ultrasonic transducer; a means for extending said passageway into the nozzle after insertion so as to minimize contact area of the fluid with the nozzle.

A further aspect of the invention relates to an ultrasonic spray device comprising: a device body; an ultrasonic transducer; a removable cartridge that is positioned within the device body, wherein the cartridge further includes: a fluid; a nozzle; a means of conveying fluid to the nozzle; a means of keeping the nozzle in contact with the transducer.

A further aspect of the invention relates to an ultrasonic spray device comprising: a device body; an ultrasonic transducer; a removable cartridge that is positioned within the device body, wherein the cartridge further includes: a fluid; a nozzle; a means of conveying fluid to the nozzle; a means of keeping the nozzle in contact with the transducer those means comprising at least one magnet.

A further aspect of the invention relates to an ultrasonic spray device comprising: a device body; an ultrasonic transducer; a removable cartridge that is positioned within the device body, wherein the cartridge further includes: a fluid; a nozzle; a means of conveying fluid to the nozzle; a means of keeping the nozzle in contact with the transducer those means comprising a suction force.

A further aspect of the invention relates to an ultrasonic spray device comprising: a device body; an ultrasonic transducer; an emission region; a removable cartridge that is positioned within the device body, wherein the cartridge further includes: a fluid; a means of conveying fluid onto the surface of the emission region.

A further aspect of the invention relates to an ultrasonic spray device comprising: a device body; an ultrasonic transducer; an emission region; a removable cartridge that is positioned within the device body, wherein the cartridge further includes: a fluid; a means of conveying fluid onto the surface of the emission region; where there is at least one orifice dispensing fluid onto the emission region.

A further aspect of the invention relates to an ultrasonic spray device comprising: a device body; an ultrasonic transducer; a nozzle; a removable cartridge that is positioned within the device body, wherein the cartridge further includes: a fluid; an enclosed space defined by a flexible material; wherein the enclosed space can be collapsed to cause the fluid to flow.

A further aspect of the invention relates to an ultrasonic spray device comprising: a device body; an ultrasonic transducer; a nozzle; a removable cartridge that is positioned within the device body, wherein the cartridge further includes: a fluid; an enclose space defined by a flexible material; wherein the enclosed space can be collapsed to cause the fluid to flow; the collapsing due to an external mechanical force.

A further aspect of the invention relates to an ultrasonic spray device comprising: a device body; an ultrasonic transducer; a nozzle; a removable cartridge that is positioned within the device body, wherein the cartridge further includes: a fluid; an enclosed space defined by a flexible material; an advancing plunger; a spring disposed against the advancing plunger.

A further aspect of the invention relates to an ultrasonic spray device comprising: a device body; an ultrasonic transducer; a nozzle; a spring; a removable cartridge that is positioned within the device body, wherein the cartridge further includes: a fluid; an enclosed space defined by a flexible material; wherein the spring is compressed upon insertion of the cartridge into the device body.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGS.” herein), of which:

FIG. 1A is a cut-away side perspective view of a handheld ultrasonic spray device with a tube-in-tube removable cartridge

FIGS. 1B-1C are section views of installation of a cartridge into the device in FIG. 1A.

FIG. 1D is a detail section view of the device in FIG. 1A with an inserted removable cartridge.

FIG. 2A is an exploded side view of a handheld ultrasonic spray device with a magnetic sonotrode.

FIG. 2B is an exploded side view of the device in FIG. 2A from an opposite side.

FIG. 2C is an exploded view of the fluid delivery contents of a disposable cartridge.

FIGS. 2D-2E are section views detailing magnetic coupling between a piezo element and a sonotrode body.

FIG. 2F is an exploded cut-away view illustrating a peristaltic pumping interface.

FIG. 3A is an exploded view of a handheld ultrasonic spray device with tip feed from a disposable cartridge.

FIG. 3B is a perspective detail view of a fluid reservoir and dispensing system and components of a permanent part of the device in FIG. 3A.

FIG. 3C is a detail perspective view of the fluid delivery and dispensing system in FIG. 3B.

FIG. 3D is a detail perspective section view of the fluid delivery and dispensing system in FIG. 3B.

FIG. 3E shows a cross section through a distribution nozzle.

FIG. 4A is a detail perspective view of a compressing bag reservoir and fluid pressurization system.

FIGS. 4B-E are detail perspective and section views of components of the compressing bag reservoir and fluid pressurization system in FIG. 4A.

FIG. 5A is a perspective view of a spray device with a pre-loaded reservoir and fluid pressurization system.

FIG. 5B is a cut-away perspective view of the spray device in FIG. 5A.

FIG. 5C is a perspective view of a pre-loaded cartridge.

FIG. 5D is a section view of a pre-loaded cartridge.

FIGS. 5E-5G are section views of the disposable cartridge detailing the steps of releasing fluid from the cartridge.

FIG. 6A is a perspective view of a spray device with a reservoir and fluid pressurization system activated upon insertion.

FIG. 6B is an exploded perspective view of the device in FIG. 6A.

FIG. 6C is a cut-away perspective view of the device in FIG. 6A.

FIG. 6D is an exploded perspective view a the cartridge.

FIGS. 6E-6G are section views detailing the steps of pressurization upon insertion of a cartridge.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

The disclosure provides systems and methods for ultrasonic spraying of fluids. In some embodiments, the disclosure provides systems and methods for spraying cosmetic fluids, such as, for example, makeup, cream, sunscreen, hairspray and/or other fluids, using handheld spray devices. The spray devices may comprise a device body, which may be housed in a cover. The cover may comprise one or more portions. The device body may comprise one or more parts. Individual body parts may or may not be housed in individual covers. The spray devices may comprise permanent components. The spray devices may further comprise removable, reusable and/or disposable components. The spray devices may comprise removable fluid cartridges. The spray devices may comprise reusable and/or disposable ultrasonic components. The spray devices may comprise reusable and/or disposable components that contact the fluid (also “wetted components” herein). Various aspects of the invention described herein may be applied to any of the particular applications set forth below or in any other type of fluid dispensing setting. The invention may be applied as a standalone method or system, or as part of an integrated fluid dispensing system. Tube-in-Tube

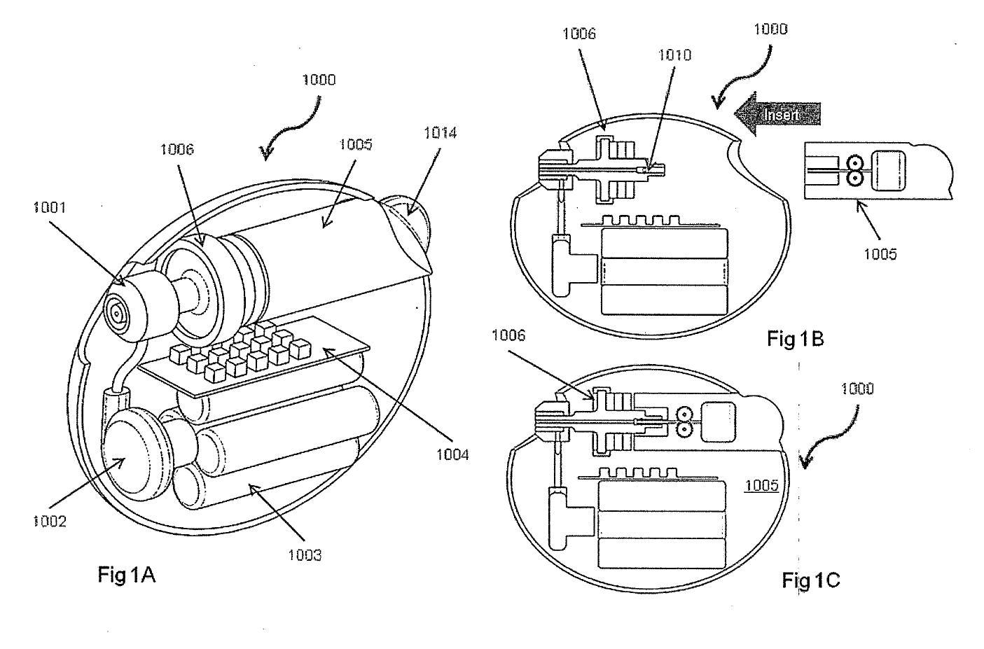

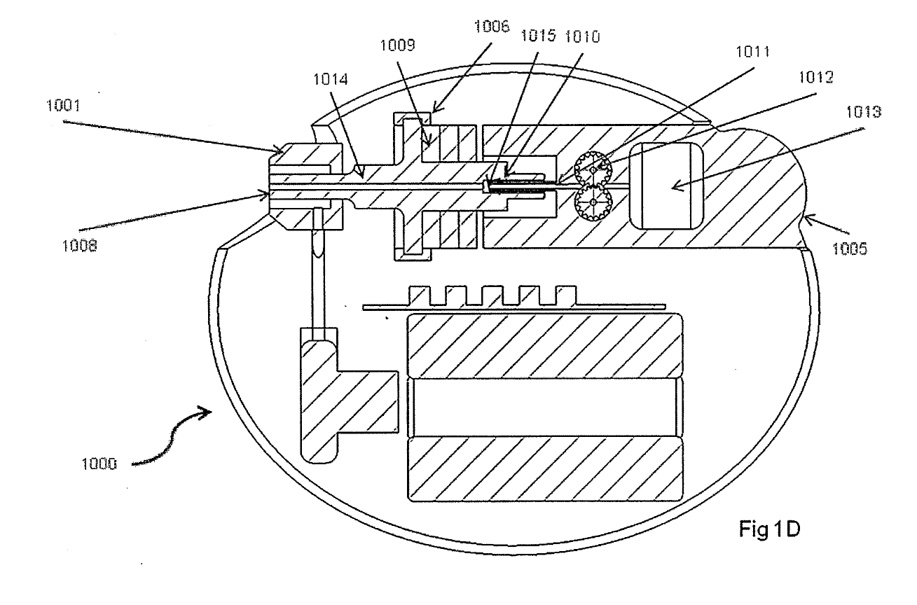

FIG. 1A is a cut-away side perspective view of a handheld ultrasonic spray device 1000 with a tube-in-tube removable cartridge in accordance with an aspect of the invention. The device 1000 may comprise a device body housed in a cover, and a removable cartridge 1005 that may be inserted through an opening in the cover. The cartridge may have a pull tab or holding feature 1014 for easy grasping of the cartridge by a user. The device 1000 may further comprise an air-shaping nozzle 1001, an air pump 1002, one or more batteries 1003, control circuitry 1004, and a sonotrode 1006. The air-shaping nozzle 1001 may be a fixed (also “permanent” herein) component of the device. The air-shaping nozzle may provide air flow to provide a set spray pattern. The air-shaping nozzle may provide an air flow that is adjustable by the user with respect to magnitude and/or location, thereby providing a plurality of coverage areas and densities of fluid spray from the device depending on the user's needs. The air pump 1002 may be of any configuration known in the art, including, but not limited to, a rotary fan, an axial fan, a diaphragm pump, a piston pump, a rotary pump, or a gear pump.

FIGS. 1B-1C are section views of the device 1000 in FIG. 1A showing an installation method of the removable cartridge 1005 into the device 1000. The cartridge is inserted into the device body as shown in FIG. 1B. Upon completed installation of the removable cartridge 1005 (FIG. 1C), the cartridge and the sonotrode 1006 may be coupled and in fluid communication with each other.

FIG. 1D is a detail section view of the device 1000 with the inserted removable cartridge 1005. The removable cartridge 1005 may include a fluid reservoir 1013, a fluid pumping means (e.g., a pump) 1012, and a connecting member 1011 for communicating the fluid from the fluid reservoir to the sonotrode 1006. The sonotrode may create ultrasonic vibrations, and the vibrational energy may be applied to the fluid. The sonotrode 1006 may comprise a stack of piezoelectric transducers 1009 attached to a sonotrode body 1014. The sonotrode 1006 may be permanent (fixed) in the device 1000. The sonotrode body 1014 may be made of a suitable material, such as, for example, aluminum, stainless steel, any steel with or without heat treatment (carbide), or titanium. The sonotrode 1006 is vibrated using the piezo stack 1009, which may be made from a suitable material, such as, for example, lead zirconate titanate (PZT) or other piezoelectric ceramic material.

In some embodiments, a low-cost disposable cartridge may be used. In this configuration, the sonotrode 1006 may not be disposable (i.e., the sonotrode may be permanent), while the removable cartridge 1005 may be disposable. Sonotrode clogging due to fluid buildup/dryout and/or cross-contamination of fluid from one disposable cartridge to the next may be minimized or eliminated by providing the connecting member (e.g., a protrusion) 1011 for communicating fluids from the pump 1012 or reservoir 1013 into the sonotrode 1006. The protrusion 1011 may partially extend into the sonotrode. Alternatively, the protrusion may extend all the way to an emission region 1008 of the sonotrode. The protrusion (also “feed tube” herein) may be deployed after cartridge insertion to bring wetted surfaces closer to the emission region. The farther the protrusion 1011 may extend into the body of the sonotrode 1006, the greater the reduction in sonotrode contamination risk. The protrusion 1011 may be rigid or flexible. In some cases, the protrusion may be self-extending from the removable cartridge 1005. In other cases, the protrusion may be extended out of the removable cartridge 1005 by the user. The configuration of the protrusion may be selected to minimize packaging constraints.

The protrusion 1011 may seal to the body of the sonotrode 1006 (i.e., to the sonotrode body 1014) via compliant sealing member, such as, for example, an o-ring 1010. One or more sealing members may be used. The sealing members may or may not be of the same type. The sealing members may include o-rings, gaskets or any other other functionally-equivalent sealing means known in the art. The sealing member 1010 may be provided inside the sonotrode 1006 prior to insertion of the protrusion, as shown for example in FIG. 1B. Alternatively, the sealing may be provided on the protrusion extending from the cartridge. In some cases, a combination of multiple protrusion provided on the sonotrode and/or on the cartridge may be used. Depending on the sealing member used, a space 1015 may be provided in the sonotrode to accommodate the sealing member, as shown in FIG. 1D.

The protrusion 1011 may communicate pressurized fluid directly from the reservoir 1013 and/or from the pump 1012. In some cases, the pump 1012 may be optional. In some embodiments, the fluid reservoir 1013 may be of a flexible, collapsing bag construction (e.g., due to no reservoir venting requirement and/or improved reservoir dispensing independent of reservoir/device orientation). In other embodiments, the fluid reservoir may be of a rigid, vented construction. In yet further embodiments, the fluid reservoir may be of a rigid, moving floor construction. Alternatively, other types of fluid reservoir configurations may be used.

The fluid reservoir 1013 may be in communication with the fluid pumping means 1012 (e.g., a gear pump, a rotary pump, a diaphragm pump, a piston pump, a peristaltic pump, or a device of any other pumping configuration). In some cases, as described in greater detail elsewhere herein, the reservoir 1013 itself may provide the pumping means via a preloaded or user applied force to the contents in the reservoir. Storage and release of this force may be accomplished through multiple means, including, but not limited to axial or torsional springs and gas-charged cylinders.

### Magnetic Sonotrode

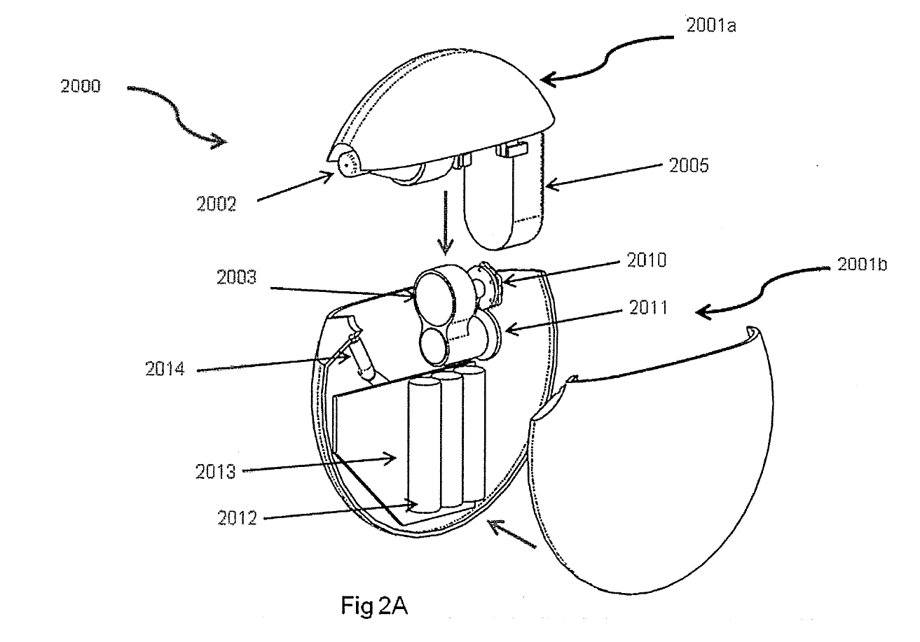

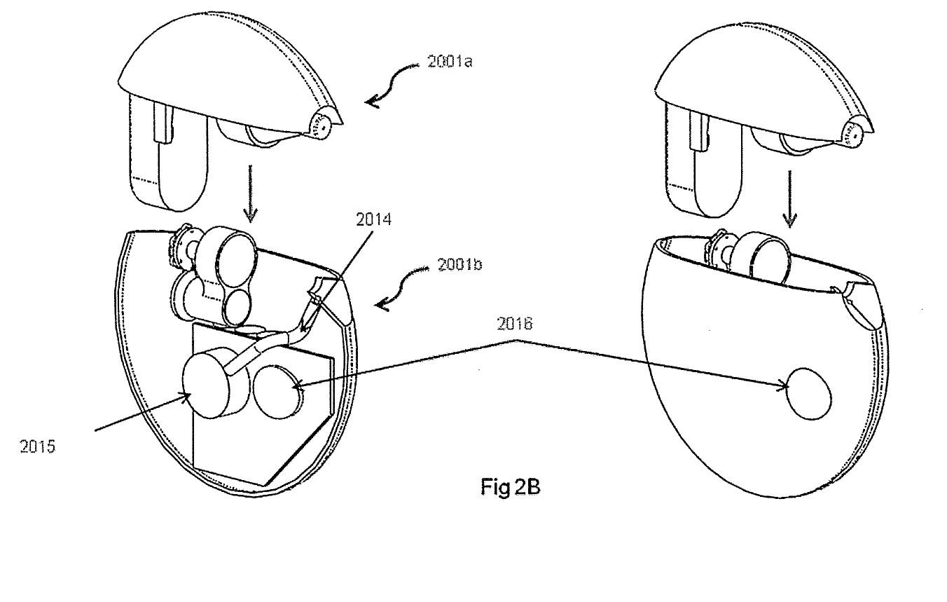

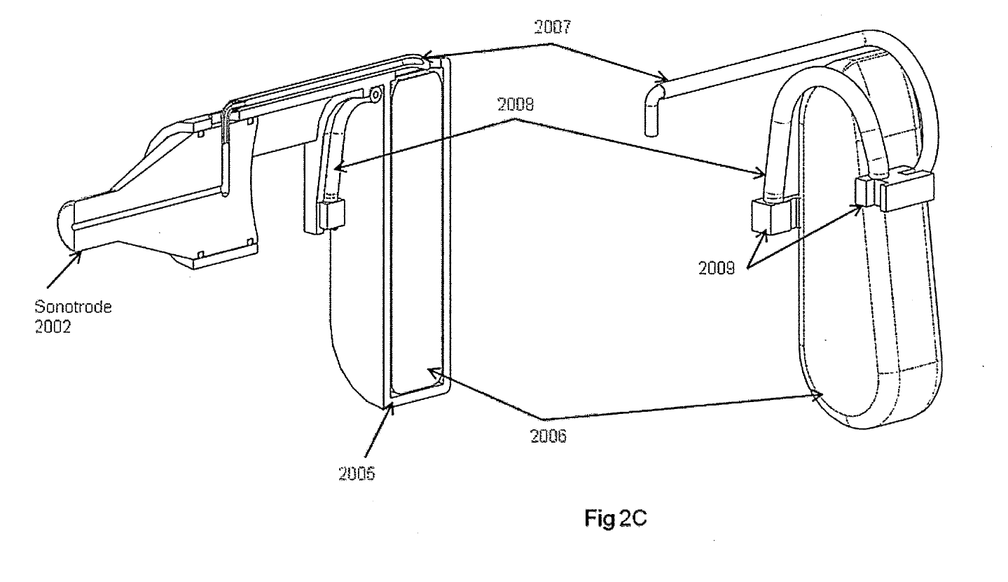

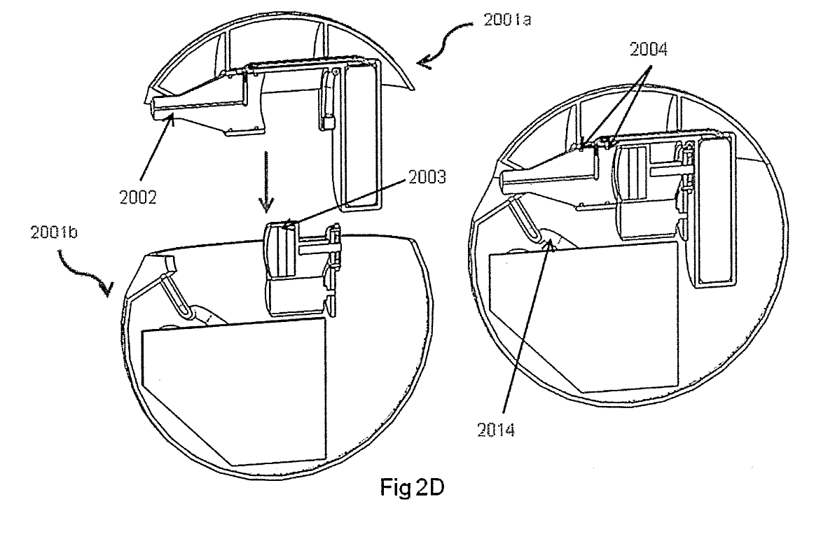

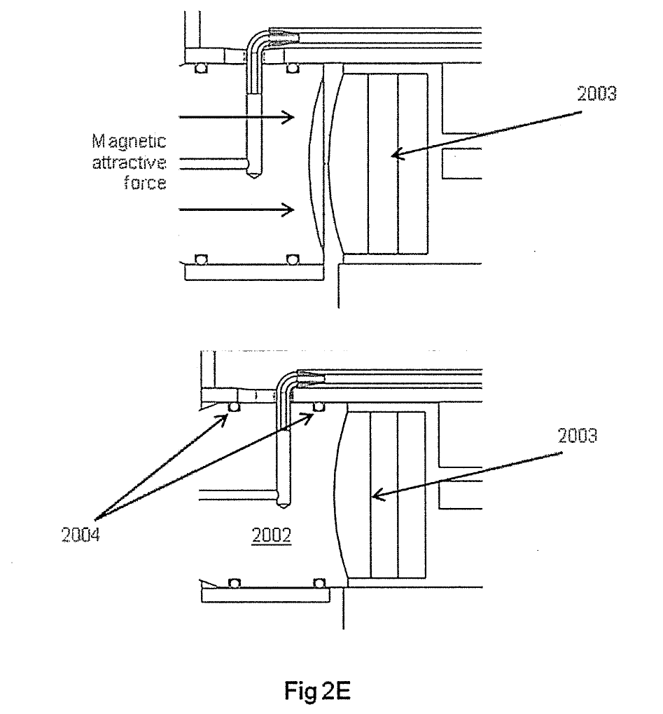

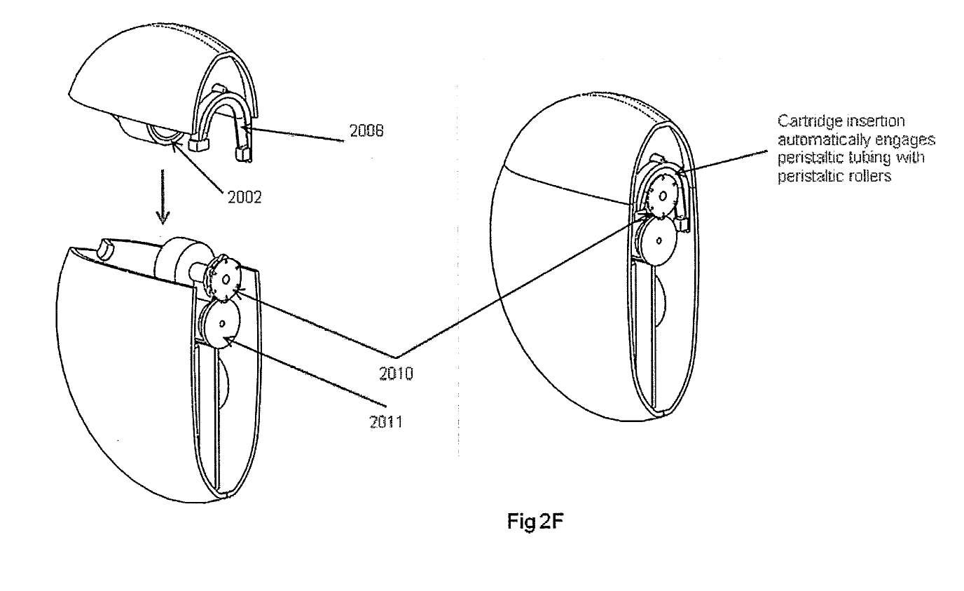

FIG. 2A is an exploded side view of a handheld ultrasonic spray device 2000 with a magnetic sonotrode in accordance with another aspect of the invention. The device may comprise a removable cartridge part 2001a and a permanent part 2001b. The parts may be housed in separate covers. The covers may comprise multiple parts, as shown, for example, for part 2001b, which comprises front and back cover portions.

FIG. 2B is an exploded side view of the device in FIG. 2A from an opposite side, with (right) and without (left) one of the cover portions housing the part 2001b. With reference to FIG. 2A and FIG. 2B, the device 2000 may comprise one or more batteries 2012, a printed cicuit board (PCB) 2013, an air pump/fan 2015, an air supply line 2014, and an activation button 2016. Alternative power sources or power supplies may be used, including internal and/or external power sources. For example, primary or secondary storage devices (e.g., batteries, capacitors, flywheels, or other energy storage devices) may be provided in the device. In another example, grid electricity may be used to externally power the device. Air pressurization may achieved using any fluid pumping means, as described elsewhere herein.

In some cases, the cover of the removable cartridge part 2001a may be reusable, while the removable cartridge 2001a without the cover may be disposable. Alternatively, the entire removable cartridge part 2001a may disposable. The removable cartridge may then be removed from the cover.

In some examples, all components wetted with fluids may be disposable (e.g., provided on the disposable cartridge), thereby decreasing or eliminating the risk of fluid contamination, mixing concerns, and clogging. This configuration may decrease or minimize the cost of the disposable cartridge 2001 while also decreasing or minimizing the risk of fluid contamination/mixing when switching from one cartridge to the next.

A sonotrode body 2002 may be integrated into the disposable cartridge 2001a. The disposable cartridge may further include a fluid reservoir in a housing 2005. A piezo element (e.g., a stack of piezoelectric transducers) 2003 may be provided in the reusable (permanent) portion of the device 2001b. The permanent part 2001b may further include peristaltic rollers 2010, motor and drive gear 2011 and other non-disposable components (e.g., the air supply line 2014). In this configuration, all air flow components may be located on the permanent part 2001b. The air supply line 2014 may eliminate the need for air connections to be broken/re-engaged during disposable cartridge removal/replacement.

With continued reference to FIG. 2A and FIG. 2B, the removable cartridge part 2001a may be inserted into the permanent part 2001b. Upon the insertion of the disposable cartridge in part 2001 into the device part 2001b, the piezo element 2003 and the sonotrode body 2002 may couple magnetically. The piezo element 2003 may be constructed from PZT (or any other piezoelectric materials known in the art) with a suitable core made of a magnetic material (e.g., by embedding the magnet) or a of a material that is ferrous, such as, for example, magnetic stainless steel.

FIG. 2C is an exploded view of the fluid delivery contents of the disposable cartridge 2001a. The disposable cartridge may comprise a fluid reservoir 2006 in a housing 2005. Beyond the reservoir 2006, fluid feed tubing 2007, peristaltic tubing 2008, and fittings 2009 for coupling the tubing may be needed to deliver pressurized fluid to the sonotrode 2002.

FIGS. 2D-2E are sectional views detailing the magnetic coupling between the piezo element 2003 and the sonotrode body 2002. The sonotrode body 2002 may be aligned and held in a pre-installed state in the disposable cartridge 2001a. Slightly energized o-rings 2004 may be used for aligning and holding the sonotrode, as shown. Alternatively, or additionally, other connecting features including, but not limited to, pull tabs, break-away tabs, features which unlatch upon cartridge installation and features which unlatch via a user-applied force or motion may also be used to position the sonotrode.

Magnetic coupling between the disposable sonotrode body 2002 and the reusable piezo element 2003 may be used to minimize necessary user interaction during disposable cartridge replacement 2001. The magnetic coupling may enable automatic engagement of the sonotrode body and the upon insertion of the disposable cartridge. In some embodiments, coupling may be achieved using alternative coupling means. For example, the disposable sonotrode body 2002 and the piezo element 2003 may be coupled through the use joints, such as, for example, threaded, quarter-turn/bayonet, tongue and groove, wedge, cam and lock, over-center latching, snap-fit and other joints or fittings.

FIG. 2F is an exploded cut-away view illustrating the interface between the peristaltic rollers 2010 in the reusable portion of the device, and the peristaltic tubing 2008 in the disposable portion of the device. Cartridge insertion may automatically engage the peristaltic tubing with the peristaltic rollers. Fluid delivery from the reservoir 2006 to the sonotrode body 2002 may be achieved through peristaltic pumping. The peristaltic pumping may be self-priming and may be considered a “dry” pumping action. Upon installation of the disposable cartridge, the peristaltic tubing 2008 may be compressed by the peristaltic rollers 2010 when the motor and drive gear 2011 are activated, thereby causing the peristaltic rollers 2010 rotate. The rotation may sequentially squeeze and relax the peristaltic tubing 2008, thereby pressurizing and pumping fluid from the reservoir 2006 to the sonotrode body 2002. The peristaltic pumping may decrease or minimize the amount of pumping equipment needed in the disposable cartridge, resulting in decreased cost. Alternative embodiments may include using, for example, gear, piston, diaphragm and rotary pumps for the fluid delivery from the reservoir 2006 to the sonotrode body 2002.

### Tip Feed

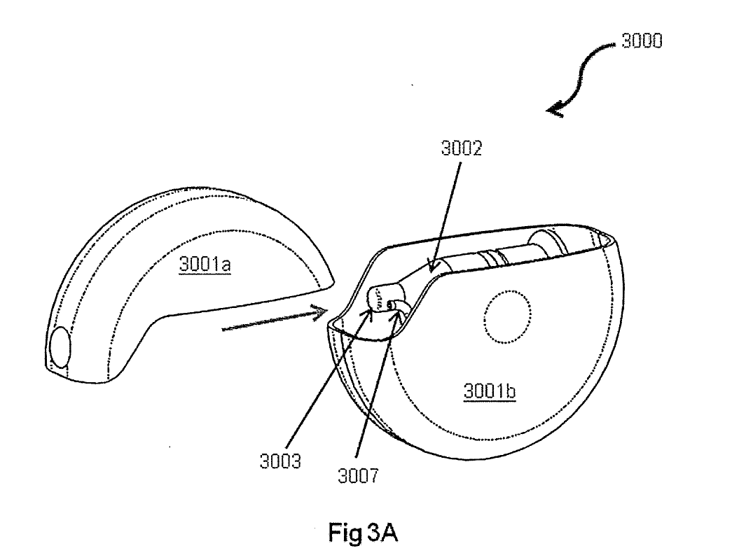

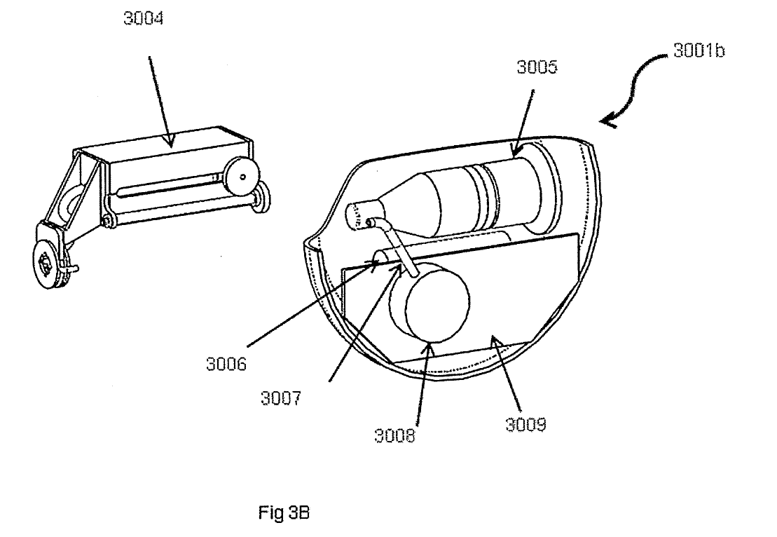

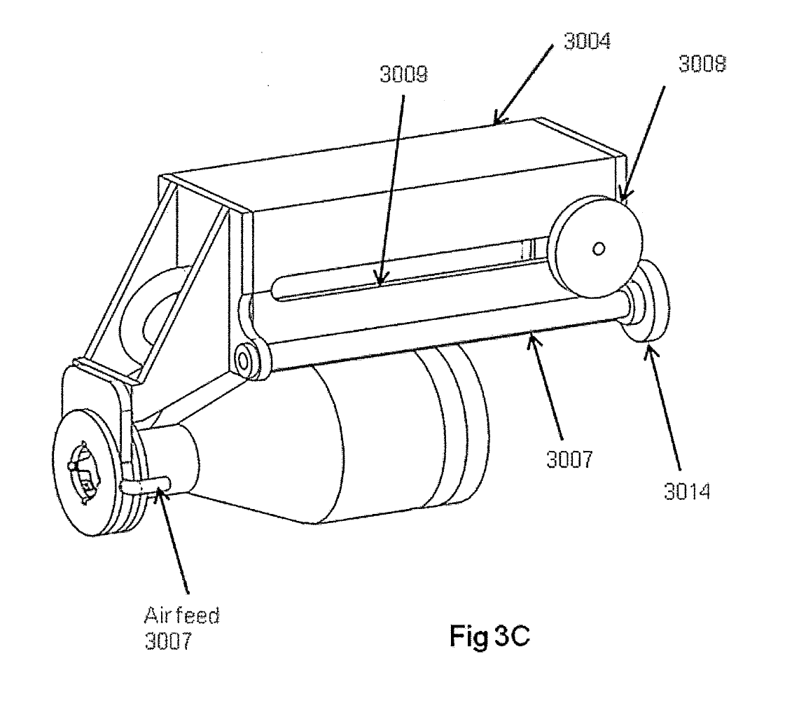

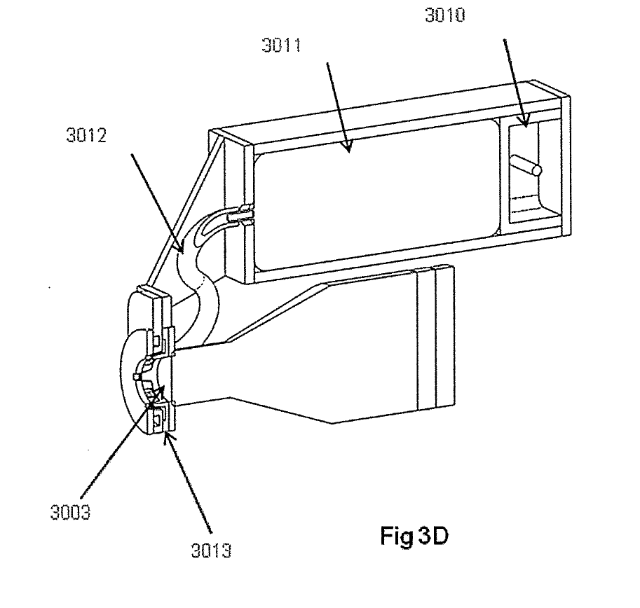

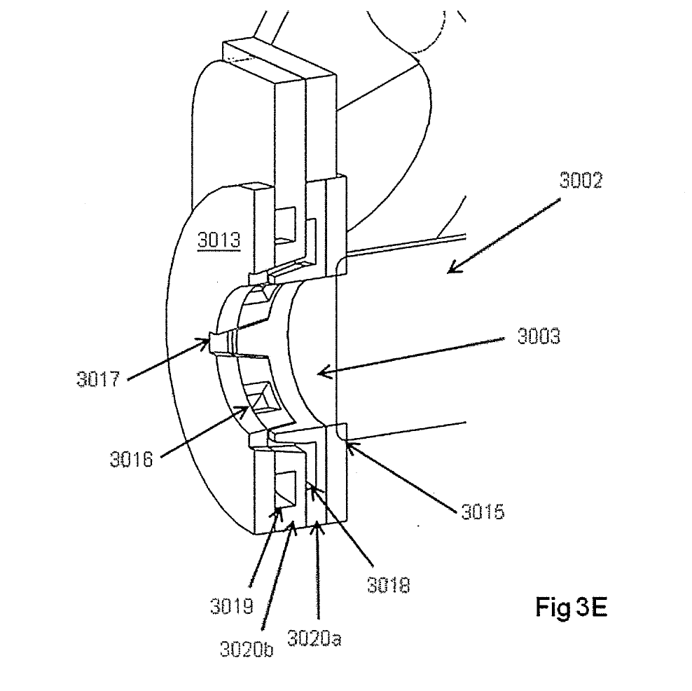

FIG. 3A is an exploded view of a handheld ultrasonic spray device 3000 with tip feed from a disposable cartridge in accordance with a further aspect of the invention. The device may comprise a disposable cartridge part 3001a and a permanent part 3001b. The parts may be housed in separate covers. In this configuration, a sonotrode 3002 (e.g., a sonotrode comprising a sonotrode body and piezoelectric transducer stack) may be provided on the the reusable (permanent) portion of the device. Fluid may be delivered from a reservoir in the disposable cartridge 3001a directly to an emission region 3003 on the sonotrode 3002 such that no fluid passes through the sonotrode and fluid may be delivered (sprayed) from the device onto a target (e.g., human skin). Thus, a low cost cartridge may be provided, with low risk of fluid mixing during cartridge replacement. The cost of the disposable cartridge 3001 may be decreased or minimized while also decreasing or minimizing the risk of fluid contamination/mixing when switching from one cartridge to the next.

FIG. 3B is a perspective detail view of a fluid reservoir and dispensing system 3004 and components of the permanent part 3001b of the device in FIG. 3A. The device may comprise a motor with a driver gear 3005 that may interface with a dispensing system on the cartridge upon cartridge installation, one or more batteries 3006, an air pump 3008, an air supply line 3007, and a PCB 3009. Again, the air pump is shown configurationally and can use any number of previously mentioned mechanisms to pressurize/move air.

In some embodiments, wiping of the emission region 3003 during cartridge replacement may further reduce or eliminate the risk of fluid mixing/contamination. The emission region may be wiped automatically during cartridge replacement. For example, automatic wiping may be performed by brushes installed on the leading edges of the cartridge (e.g., on the leading edge of the cartridge 3001a that first contacts the permanent part 3001b during installation, as indicated by the arrow in FIG. 3A). More complicated automatic brushing mechanisms may be provided. For example, triggered electromechanical or purely mechanical wiping action may be used. In other examples, mechanisms of intermediate complexity and/or combinations of several wiping mechanisms may be used. In another example, wiping may be provided by a directed burst of compressed air onto the emission region upon cartridge removal. Such an action may be initiated, for example, by pressing a cartridge clean button or control, and/or automatically as a result of displacing the cartridge by a predetermined distance. Alternatively, the emission region may be wiped manually by the user.

FIGS. 3C-3D are detail perspective views of the fluid delivery and dispensing system 3004. The motor with driver gear 3005 (shown in FIG. 3B) may interface with a driven gear 3014, which may be coupled to a lead screw 3007. As the lead screw 3007 turns with the driven gear 3014, an advancement gear 3008 may also turn due to its engagement with the lead screw 3007. The advancement gear 3008 may also be engaged with a rack 3009 (teeth not shown) such that as the advancement gear 3008 spins, it also translates along the length of the fluid delivery and dispensing system. The advancement gear 3008 may be coupled to a dispensing plunger 3010 such that as the advancement gear translates, the dispensing plunger does so as well. This translation of the dispensing plunger 3010 may pressurize the fluid in a reservoir 3011, pushing it through a fluid feed hose 3012 into a distribution nozzle 3013 and onto the emission region 3003.

FIG. 3E shows a cross section through the distribution nozzle 3013. The distribution nozzle may be of an axially symmetric, circular shape. In some embodiments, other shapes of the distribution nozzle may be used (e.g., square, rectangular, oval, custom shaped to fit into a slot or crevice etc.) The distribution nozzle may dispense fluid onto the surface of the emission region 3003 and distribute air into the atomized fluid plume, thereby adjusting the shape of the plume into one suitable for the sprayed medium (also “fluid” herein). Fluid supply ports 3016 and air supply ports 3017 may be located circumferentially around the distribution nozzle. The fluid and air supply ports 3016, 3017 may or may not be equally spaced, depending on the atomized plume shape desired. The distribution nozzle may comprise 1, 2, 3, 4, 5, 7, 10, 12 or more fluid supply ports 3016. The fluid supply ports may be equally spaced apart along the distribution nozzle (e.g., circumferentially along an inside edge of the distribution nozzle); alternatively, the fluid supply ports may be spaced out in a predetermined pattern (e.g., clustered orifices, randomly spaced orifices, etc.). Further, the distribution nozzle may comprise 1, 2, 3, 4, 5, 7, 10, 12 or more air supply ports 3017. The air supply ports may be equally spaced apart along the distribution nozzle (e.g., circumferentially along an inside edge of the distribution nozzle); alternatively, the air supply ports may be spaced out in a predetermined pattern (e.g., clustered orifices, randomly spaced orifices, etc.).

The fluid and air supply ports 3016, 3017 may comprise one or more orifices for dispensing fluid onto a surface of the emission region. The shape of individual orifices may be square, rectangular, circular and/or of a compound shape (e.g., comprising a swirling feature or a bluff body, comprising an angled orifice entrance or exit, comprising internal channel structure, comprising multiple concentric, parallel or otherwise arranged orifices, etc.). For example, one or more fluid supply ports may dispense fluid radially toward a center of the distribution nozzle, and/or in a direction having a radial component and an axial component (e.g., in a direction angled away from the emission region, or in a direction angled toward the emission region). Similarly, one or more air supply ports may dispense air radially and/or axially (e.g., in a direction guiding the fluid spray toward a chosen target region). For example, the air supply port may have an angled orifice exit to allow for directionality of the air flow in a predetermined direction (e.g., in accordance with user settings). The fluid and air supply ports 3016, 3017 may also be adjustable in terms of size, shape, and location, either by the user, or automatically by the device. Adjustment of the fluid and air supply ports 3016, 3017 may be used to adjust for varying fluids and coverage areas. The fluid and air supply ports 3016, 3017 may be fed via fluid and air supply channels 3018, 3019 on isolated layers of the distribution nozzle. Each of the supply channels may be direct communication with fluid and air supply lines from the reservoir and the pump, respectively. For example, the fluid supply ports 3016 and the fluid supply channels 3018 may be provided through a manifold structure in a first layer 3020a of the distribution nozzle, while the air supply ports 3017 and the air supply channels 3019 may be provided through a manifold structure in a second layer 3020b of the fluid distribution nozzle.

In some embodiments, orifices (e.g., the fluid and air supply ports 3016, 3017) may be provided separately from manifold structures and/or feed channels. For example, one or more individual orifices may be provided separately from but in proximity to the emission region. The orifices may dispense fluid onto a surface or feature of the emission region. The one or more orifices and/or the distribution nozzle may be provided separately from but in proximity to the emission region. The one or more orifice may not be formed in (or within) the emission region. For example, the distribution nozzle in FIG. 3E may have a first end proximal to the emission region (e.g., spaced apart from, the emission region by a first predetermined distance) and a second end distal to the emission region (e.g., spaced apart from the emission region by a second predetermined distance). The distribution nozzle may have a thickness (e.g., the second predetermined distance minus the first predetermined distance). As shown in FIGS. 3D-3E, the distribution nozzle may be located at a distal end of the device and the emission region may be located at a proximal position relative to the distal end of the device. The distribution nozzle and the emission surface may be separated by a predetermined distance.

The one or more orifices may be located in a plane (e.g., in a layer of the distribution nozzle). In some examples, one or more ends of the distribution nozzle, the orifice plane and/or one or more individual orifices may be spaced apart from the emission region by a predetermined distance of, for example, less than or about 0.1 mm, less than or about 0.5 mm, less than or about 1 mm, less than or about 2 mm, less then or about 5 mm, less than or about 1 cm, less than or about 2 cm, or more than 2 cm. For example, one or more fuel supply ports (or orifices) may be spaced apart from the emission region by a first predetermined distance, while one or more additional fuel supply ports (or orifices) may be spaced apart from the emission region by a second predetermined distance. Any description of a predetermined distance of the fuel supply ports may also be applied to air supply ports.

The sonotrode 3002 may interface with the distribution nozzle 3013 through a compliant (e.g., flexible) component 3015 that may provide a buffer between the actively vibrating sonotrode and the disposable cartridge. Further, the cartridge itself may be compliantly secured in the device 3000. The compliant component 3015 may also provide a seal between the sonotrode 3002 and the distribution nozzle 3013, thereby preventing dispensed fluid from leaking into the device. Compliant members may include any flexible or sealing members described elsewhere herein, such as, for example, flexible membranes, polymer gaskets, o-rings etc.

### Compressing Bag

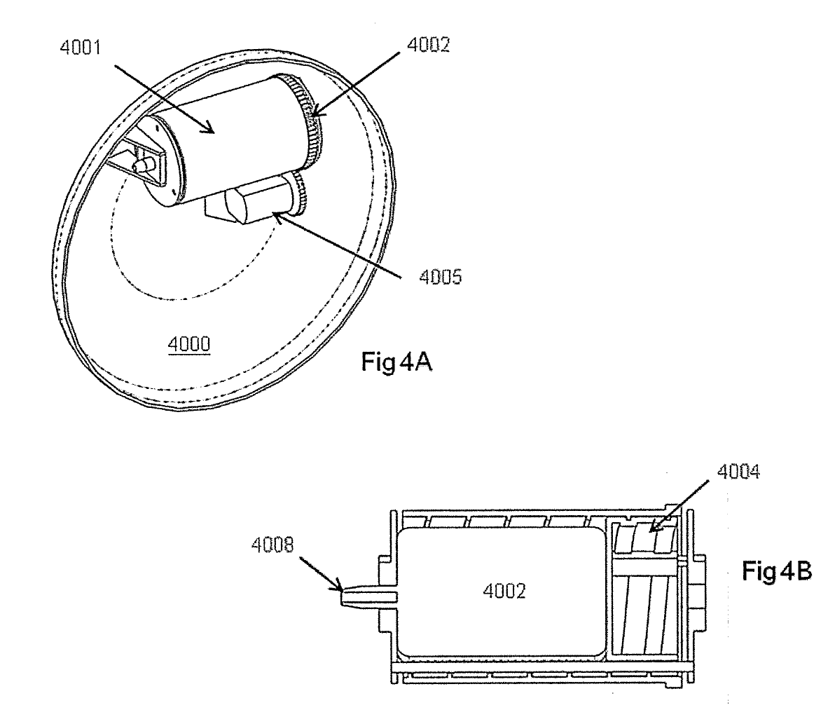

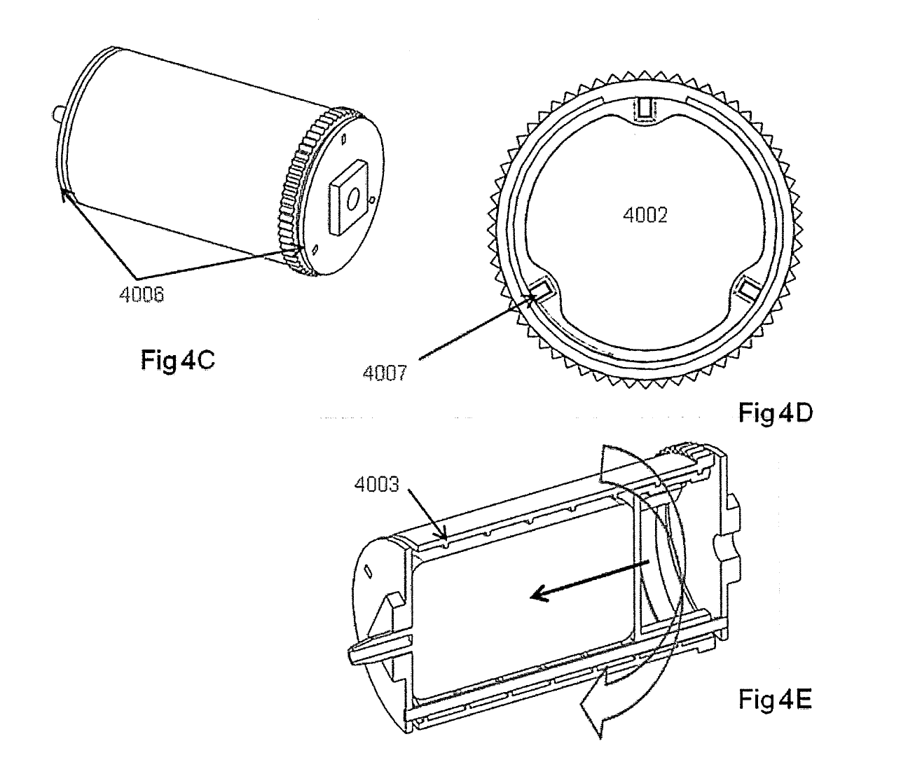

FIG. 4A is a detail perspective view of a compressing bag reservoir and fluid pressurization system in accordance with a further aspect of the invention. The system may be provided on a spray device 4000 in accordance with aspects of the disclosure. The system may comprise a reservoir with an external housing 4001. The external housing 4001 may or may not be disposable. A collapsible pouch 4002 for holding a fluid may be housed in the external housing. In some embodiments, the collapsible pouch may be disposable. Alternatively, the collapsible pouch may be refillable. The pouch may be directly pressurized, resulting in controlled ejection of the fluid within the pouch. Direct pressurization and fluid dispensing from a disposable pouch may provide advantages including single sealing point (e.g., compared to the fluid being transferred to a pump for pressurization), no dispensing issues regardless of reservoir orientation, and no reservoir venting requirements.

FIGS. 4B-E are detail perspective and section views of components of the reservoir and fluid pressurization system in FIG. 4A. Fluid may be pressurized by an externally threaded plunger 4004 which may, as it advances, compress the fluid pouch 4002. Advancement of the plunger 4004 may be achieved through rotation of the housing 4001 by a drive motor 4005. The housing may be internally threaded 4003 and externally toothed 4002. The external threads may be provided in a region on the housing adjacent to the drive motor 4005, as shown in FIG. 4A, such that the teeth may engage with mating teeth on the drive motor. The plunger 4004 may translate along one or more ribs 4007. End plates 4006 of the reservoir housing may be fixed. Further, the end plates may interlock with or tie into the ribs 4007, such that the only the plunger moves in response to the rotation of the motor 4005. Thus, the motor rotation may be translated to fluid pressurization. Fluid may exit the compressed pouch via a nozzle 4008. The nozzle may be opened by user-applied force, or though electromechanical means. In some cases, the nozzle may comprise a check valve of appropriate cracking pressure to prevent fluid leakage when pressures are too low. In some cases, the valve may be opened by an actuator. In some cases, valves may be opened by ultrasonic vibration.

In some embodiments, the fluid in the collapsible pouch may be pressurized using an alternative plunger advancement configuration. For example, alternative configurations for advancing the plunger may include, but are not limited to, racks, lead screws, closing plates, or inductive means.

The collapsible pouch may be pressurized automatically by the device and/or manually by the user (e.g., as part of actively turning on and operating the device and/or as an initial step when powering on the device).

In some embodiments, one or more fluid pressurization systems of spray devices in accordance with the invention may be driven by the same motor as an air pump provided on board the device.

### Pre-Loaded Cartridge

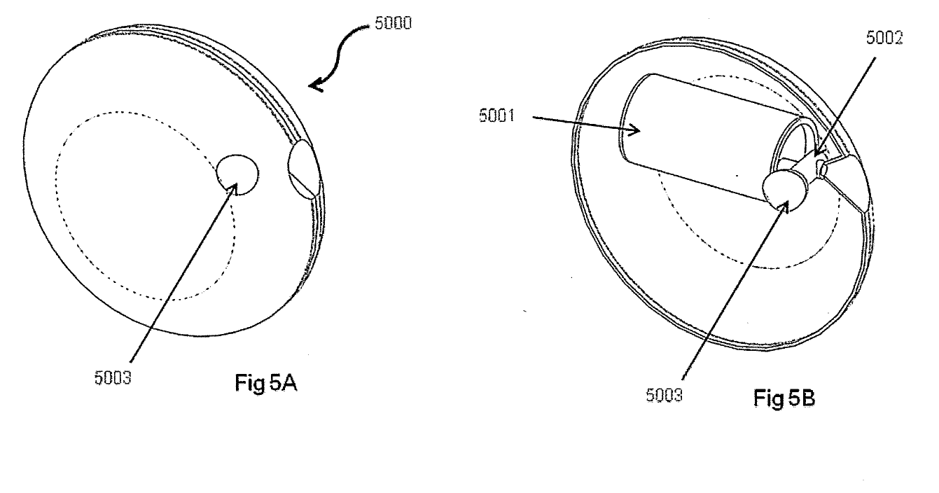

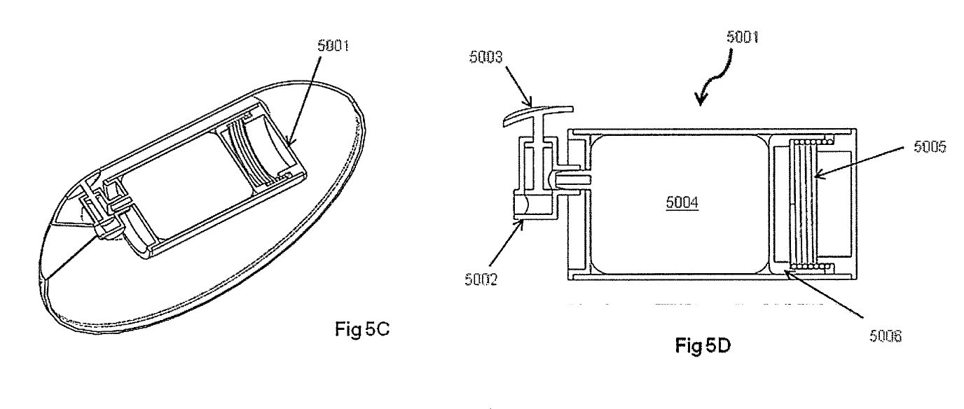

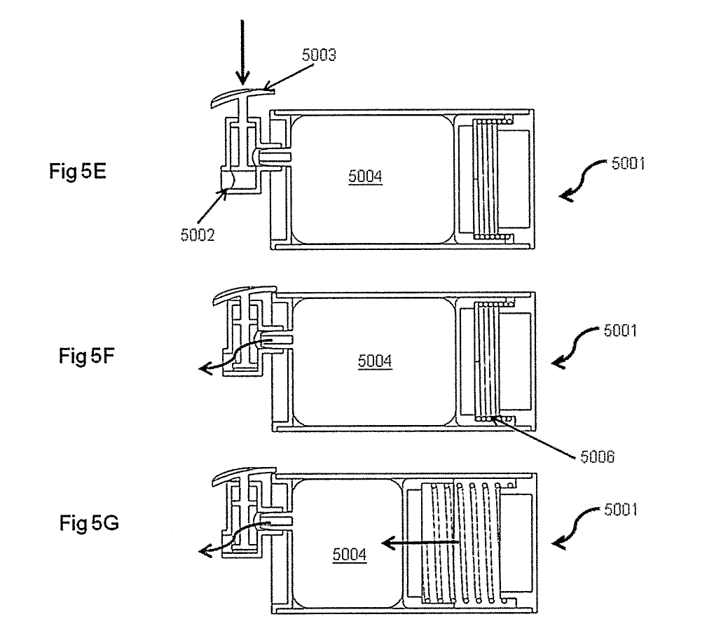

FIGS. 5A-5B are perspective views of a spray device 5000 with a pre-loaded reservoir and fluid pressurization system in accordance with yet another aspect of the invention. In this configuration, the fluid stored a disposable cartridge 5001 may be pre-pressurized before use. The release of the contents of the cartridge may be controlled by a valve 5002. The valve 5002 may be activated through a user interaction point 5003 (e.g., a button, touch pad, switch or other type of control feature) through a direct mechanical connection to the valve or via electro-mechanical means. For example, as shown in FIGS. 5A-5B, the valve may be accessed directly on the body of the device 5000. In this configuration, pumping and associated components may be eliminated from the device 5000, thereby enabling reduced complexity and cost. In some cases, the disposable cartridge may be outfitted with a lock mechanism for accidental release of pressurized fluid.

FIGS. 5C-5D are perspective and section views, respectively, of the disposable cartridge 5001. In this configuration, fluid may be stored in, directly pressurized, and released from a collapsible pouch 5004. The pouch may be pressurized by a compressed spring 5005 interacting with an advancing plunger 5006. Controlled fluid release may be provided through direct and/or indirect control of a dispensing valve 5002, such as, for example, when a user interacts with the interaction point 5003. In some cases, controlled fluid release may be automatically provided by the device during operation.

FIGS. 5E-5G are section views of the disposable cartridge, detailing the steps of releasing fluid from the collapsible pouch 5004 and the mechanical response of the system. The user interaction point 5003 may be mechanically activated (e.g., pressed), as shown in FIG. 5E, opening the valve 5002. In a next step, shown in FIG. 5F, the fluid in the cartridge exits the cartridge through the open valve. As fluid exits the cartridge, the spring-loaded plunger 5006 advances forward in response to the reduced fluid pressure.

In some embodiments, cartridge configurations may include a collapsible pouch with an integrated, rigid endcap (e.g., eliminating the need for an advancing plunger), pouch pressurization through direct gas charging or indirectly through a chemical reaction when dispensing is needed (e.g., for reducing accidental fluid discharge risk), and/or a rigid reservoir with a moving floor and charging in accordance with any of the charging configurations described in herein (e.g., as an alternative to the collapsible pouch). For example, the cartridge configurations may use spring-loaded pre-loading. In some cases, spring-loading may be replaced or combined with one or more other means for pre-loading, such as, for example, hydraulic means utilizing an air pump on board the spray device.

### Pressurization Upon Insertion

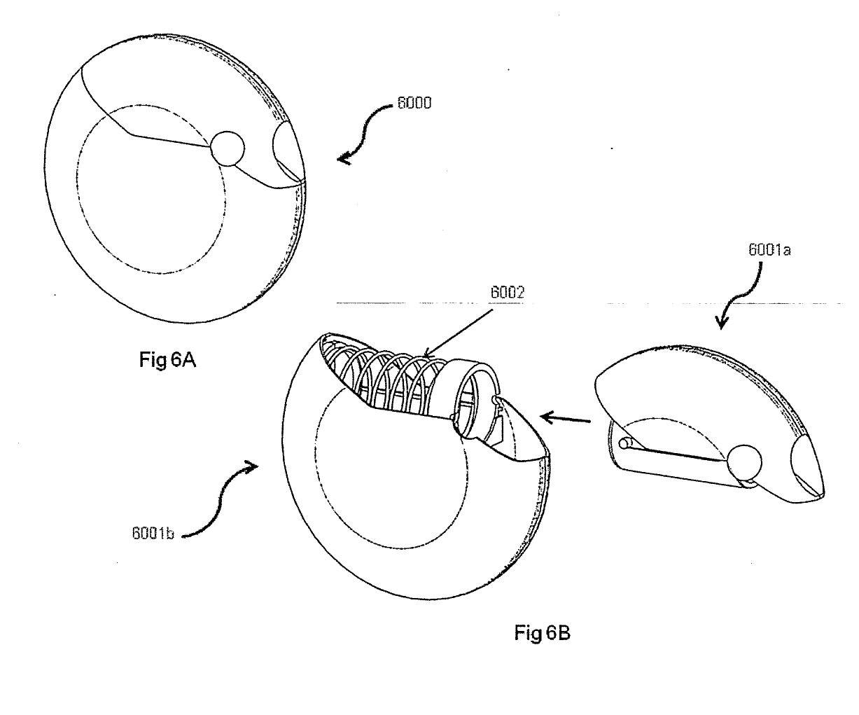

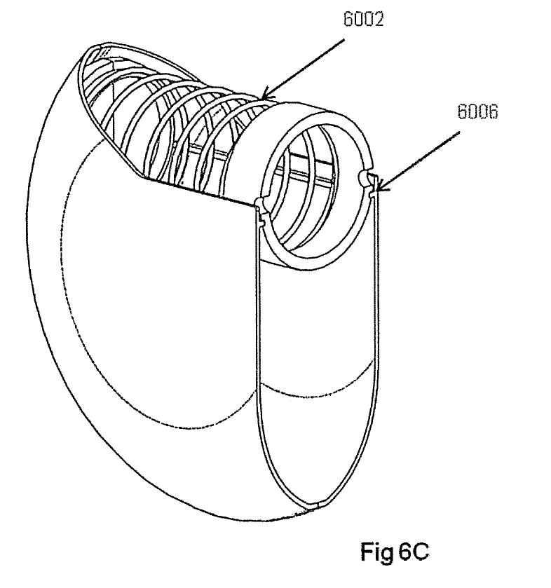

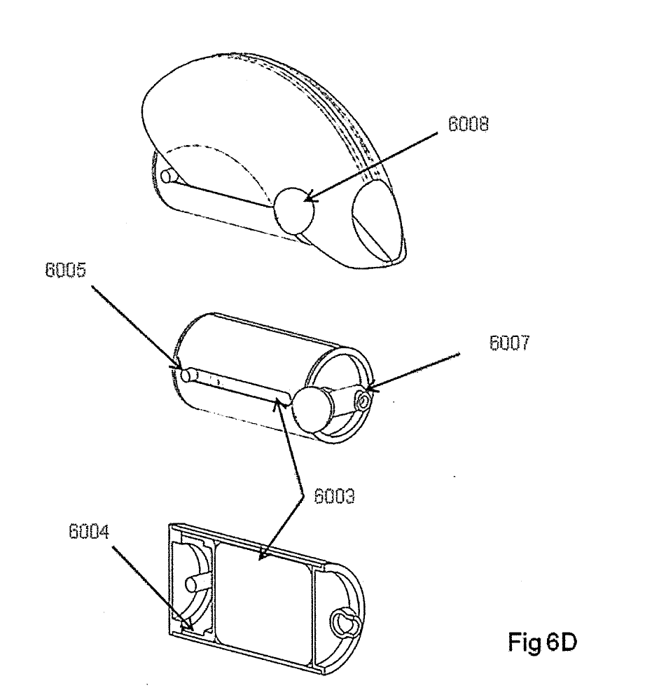

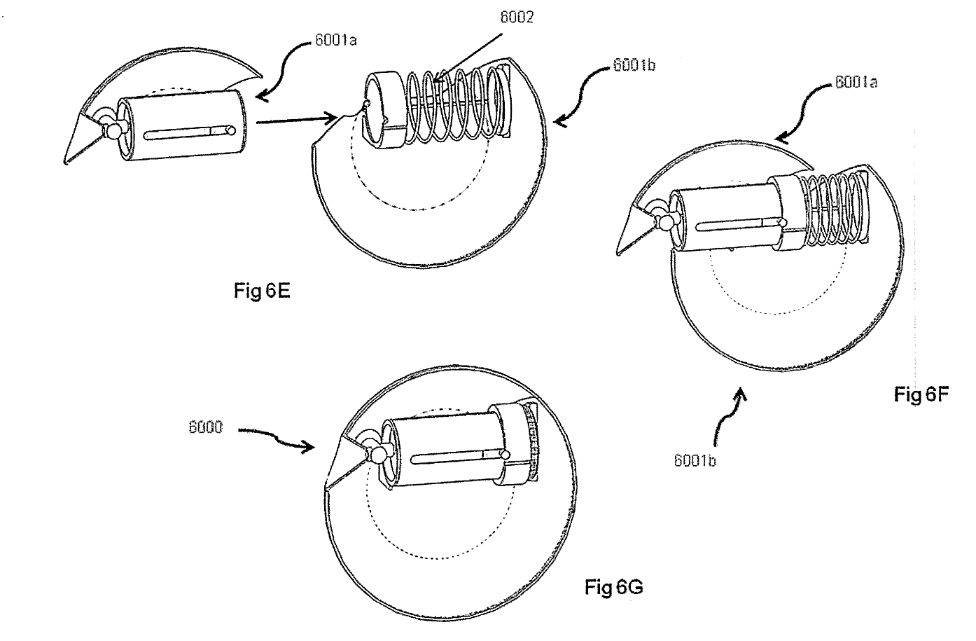

FIG. 6A is a perspective view of a spray device 6000 with a reservoir and fluid pressurization system activated upon insertion in accordance with yet another aspect of the invention. FIG. 6B is an exploded perspective view of the device 6000. FIG. 6C is a cut-away perspective view of the device 6000. With reference to FIGS. 6A-6C, the device may comprise a cartridge part 6001a (e.g., comprising a cartridge and a separable cartridge cover) and a permanent part 6001b. Fluid stored in the cartridge 6001a may be pressurized when installed into the device 6000. The fluid may remain pressurized only when the cartridge is in the device. This configuration may significantly decrease risk of accidental fluid discharge.

Fluid pressurization may be provided through deflection of an energy storage component upon cartridge insertion. For example, the energy storage component may be an axial spring 6002. Alternatively, the energy storage component may be a torsion, leaf, or elastomeric spring, along with multiple other forms of energy storage, such as compressed air or other fluid. The force required to deflect the energy storage component may be applied by the user. In some embodiments, various forms of mechanical means may be used to reduce the force application required by the user. For example, a means for automatically compressing the spring prior to insertion may be provided (e.g., when activated by a button or other control pressed by the user, a hook may compress the spring and hold it in place until the cartridge has been inserted), such that negligible user-provided force may be required when inserting the reservoir. In another example, an electromagnetic or other force may be applied to compress and hold back the spring. In some cases, for example when the energy storage component is compressed air, the air may be automatically pressurized to a higher pressure prior to insertion, and then vented or released to operating pressure after insertion of the cartridge.

FIG. 6D is an exploded perspective view of the cartridge 6001a. Fluid may be stored in a collapsible pouch 6003 (e.g., a collapsible pouch described elsewhere herein). In some cases, the cartridge 6001 may be disposable. In other cases, the cartridge 6001 may be reusable with only the pouch being disposable. Further, the pouch may also be refillable.

With reference to FIGS. 6C-6D, the pouch may be pressurized through the interaction of an advancing plunger 6004 and the pressurization spring 6002. A protrusion 6005 on the advancing plunger may be guided within the casework of the cartridge 6001. Further interface stability may be provided by rails 6006 for guiding the pressurization spring 6002. In some embodiments, for example when an alternative energy storage component is used, the rails 6006 may or may not be provided. In some cases, other complementary (e.g., mating) features may be used as alternatives or in addition to the protrusion 6005 and rails 6006. Fluid release may be controlled by direct or indirect control of the dispensing valve 6007, such as, for example, when a user interacts with the interaction point 6008, as described elsewhere herein. In some cases, controlled fluid release may be automatically provided by the device during operation.

FIGS. 6E-6G are section views detailing the steps of pressurization upon insertion of the cartridge part 6001a into the main device part 6001b, and the mechanical response of the system. The cartridge may be installed into the device by moving the cartridge toward the main device part, as indicated by the arrow in FIG. 6E. FIG. illustrates the alignment and insertion of the cartridge to the main device portion, during which the spring (or an alternative energy storage component) may be compressed. FIG. 6G details the installed cartridge.

Aspects of the disclosure may be combined to enable various combinations of disposable and reusable components. Such combinations may, for example, enable more expensive components to be reused, and contamination between fluid changes to be minimized or eliminated through disposal of wetted parts (e.g., making it easier to change out cartridges containing different fluids) . For example, various embodiments may combine disposable wetted components in accordance with aspects of the disclosure with disposable piezoelectric components (or parts thereof) in accordance with aspects of the disclosure. In another example, disposable wetted components in accordance with aspects of the disclosure may be combined with reusable piezoelectric components (or parts thereof) in accordance with aspects of the disclosure. As described in more detail elsewhere herein, piezoelectric components (e.g., sonotrode) may include one or more parts that are wetted components (e.g., sonotrode body). Further, aspects of the disclosure may be synergistically combined. For example, a collapsible pouch may advantageously be used in combination with a system for pressurization upon insertion, as the collapsible pouch may reduce overall cartridge length compared to, for example, a rigid reservoir with a moving floor. The reduced overall cartridge length may be desired to reduce the deflection of the energy storage component needed upon cartridge insertion.

It is to be understood that the terminology used herein is used for the purpose of describing specific embodiments, and is not intended to limit the scope of the present invention. It should be noted that as used herein, the singular forms of “a”, “an” and “the” include plural references unless the context clearly dictates otherwise. In addition, unless defined otherwise, all technical and scientific terms used herein have the same meaning as commonly understood by one of ordinary skill in the art to which this invention belongs.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An ultrasonic spray device comprising:
a device body comprising an ultrasonic transducer coupled to an emission region; and
a removable cartridge positioned within the device body, said removable cartridge comprising a fluid reservoir and a system for delivering fluid from the fluid reservoir to an orifice separate from but in proximity to the emission region, said orifice for dispensing the fluid onto a surface of the emission region.
